(19) United States
(12) Patent Application Publication
(10) Pub. No.: US 2024/0046714 A1
(43) Pub. Date: Feb. 8, 2024

(54) VEHICLE INFORMATION MANAGEMENT METHOD AND VEHICLE INFORMATION MANAGEMENT APPARATUS

(71) Applicant: Honda Motor Co., Ltd., Tokyo (JP)

(72) Inventors: Koki Osanai, Wako-shi (JP); Daisuke Sawai, Wako-shi (JP); Shinji Mikami, Tokyo (JP); Daisuke Tamaki, Wako-shi (JP); Yoshihiro Tsujino, Tokyo (JP)

(21) Appl. No.: 18/229,916

(22) Filed: Aug. 3, 2023

(30) Foreign Application Priority Data
Aug. 8, 2022 (JP) 2022-126109

(51) Int. Cl. G07C 5/00

(52) U.S. Cl. CPC G07C 5/008

(57) ABSTRACT

A vehicle information management method for managing vehicle information linked with a vehicle, includes the steps of including status information indicating a status of the vehicle information into the vehicle information; decorating the status information based on travel information of the vehicle; permitting a user of the vehicle to view the vehicle information through an information terminal; and generating the vehicle information as a non-fungible token to be recorded in a blockchain.

### CROSS-REFERENCE TO RELATED APPLICATION

This application is based upon and claims the benefit of priority from Japanese Patent Application No. 2022-126109 filed on Aug. 8, 2022, the content of which is incorporated herein by reference.

### BACKGROUND OF THE INVENTION

### Field of the Invention

This invention relates to a vehicle information management method and a vehicle information management apparatus configured to manage vehicle information regarding a vehicle used by a user.

### Description of the Related Art

Services using a non-fungible token (NFT) technology have increased (see, for example, JP 2021-152815 A and JP 2022-059707 A).

There is no service in which the NFT technology is associated with users of moving bodies such as four-wheeled vehicles and two-wheeled vehicles among a plurality of services being implemented or proposed.

### SUMMARY OF THE INVENTION

An aspect of the present invention is a vehicle information management method for managing vehicle information linked with a vehicle, including the steps of: including status information indicating a status of the vehicle information into the vehicle information; decorating the status information based on travel information of the vehicle; permitting a user of the vehicle to view the vehicle information through an information terminal; and generating the vehicle information as a non-fungible token to be recorded in a blockchain.

Another aspect of the present invention is a vehicle information management apparatus configured to manage vehicle information linked with a vehicle, including: a processor and a memory coupled to the processor. The processor is configured to perform: including status information indicating a status of the vehicle information into the vehicle information; decorating the status information based on travel information of the vehicle; permitting a user of the vehicle to view the vehicle information through an information terminal; and generating the vehicle information as a non-fungible token to be recorded in a blockchain.

### BRIEF DESCRIPTION OF THE DRAWINGS

The objects, features, and advantages of the present invention will become clearer from the following description of embodiments in relation to the attached drawings, in which:

FIG. 1 is a view illustrating a communication terminal that displays an image based on vehicle information;

FIG. 2 is a schematic configuration diagram of a vehicle information management system according to an embodiment of the present invention;

FIG. 3 is a block diagram illustrating a configuration of a main part of a server device of FIG. 2;

FIG. 4 is a block diagram illustrating a configuration of a main part of the communication terminal of FIG. 2;

FIG. 5 is a block diagram illustrating a configuration of a main part of an in-vehicle terminal of FIG. 2;

FIG. 6 is a flowchart illustrating a flow of vehicle information management processing performed by the server device; and

FIG. 7 is a flowchart illustrating a flow of another vehicle information management processing performed by the server device.

### DETAILED DESCRIPTION OF THE INVENTION

An embodiment of the present invention will be described below with reference to the drawings.

<Outline of Vehicle Information>

A vehicle information management apparatus according to the embodiment of the present invention manages information regarding a vehicle (referred to as vehicle information) used by a user. The vehicle information includes image information, basic information, and setting information. The vehicle information is configured as a non-fungible token (NFT) recorded in a distributed database network called a block chain.

In the embodiment, an example in which a user who has purchased or rented an electric vehicle from a business operator or the like who sells vehicles or the like purchases the vehicle information as a vehicle option will be described. The vehicle may be a two-wheeled vehicle or the like other than a four-wheeled vehicle, or a compact vehicle such as a micro-mobility vehicle.

Note that the vehicle information may be borrowed instead of being purchased, or may be distributed or transferred free of charge from the business operator or the like to a purchaser or the like of a vehicle.

In addition, the business operator or the like may sell, lend, or distribute only the image information out of the vehicle information to the user as a vehicle option.

<Image Information>

The image information included in the vehicle information includes at least one of an image reflecting the whole and/or a part of a vehicle used by a user who has purchased the vehicle information, and an image including a drawing, a sketch, an illustration, and the like through which a configuration or the like of the vehicle can be seen. In the embodiment, an example in which data of an image related to a vehicle of the same vehicle type as the vehicle used by the user is used as the image information will be described, but data of an image related to a vehicle of a vehicle type different from that of the vehicle used by the user may be used.

<Basic Information>

The basic information included in the vehicle information includes data of inspection and maintenance for the vehicle used by the user who has purchased the vehicle information. For example, the basic information may include data such as an inspection and maintenance record of the vehicle, a travel distance of the vehicle, a state of charge of a battery mounted on the vehicle, a remaining amount of lubricating oil of the vehicle, and air pressures of tires.

<Setting Information>

The setting information included in the vehicle information includes data indicating setting states of functions (a setting content of enabling or disabling for each of the functions or the like) provided in the vehicle used by the user who has purchased the vehicle information.

<Viewing of Vehicle Information by User>

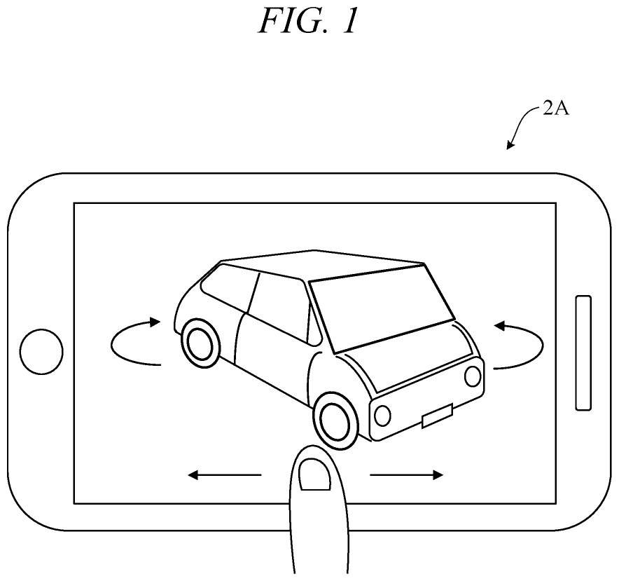

The user who has purchased the vehicle information can view the vehicle information regarding the vehicle used by the user. More specifically, the vehicle information management apparatus permits the user to view the vehicle information regarding the vehicle used by the user via, for example, a communication terminal 2A used by the user. FIG. 1 is a view illustrating the communication terminal 2A that displays an image based on the image information included in the vehicle information.

In addition, when a display screen of the communication terminal 2A displaying the image related to the vehicle is swiped with a finger or the like, the vehicle information management apparatus permits viewing of an image of the vehicle viewed from a direction corresponding to the swipe operation.

The image information may be information of a two-dimensional (2D) image (for a planar view) or information of a three-dimensional (3D) image (for a stereoscopic view). In a case where the image information is the information of the 3D image, the user who has purchased the vehicle information can view the image information as the 3D image by connecting a head-mounted display called virtual reality (VR) goggles (not illustrated) to the communication terminal 2A, for example. The connection of the display or the like may be a wired connection or a wireless connection.

The vehicle information management apparatus prepares a plurality of pieces of image information in advance as image materials for generating image information to be included in the vehicle information. For example, a plurality of images different in at least one of an appearance of the vehicle (a plurality of appearances depending on a difference in grade, a difference due to the presence or absence of an optional component, a difference due to an attitude of the vehicle, and the like), a coating color of the vehicle, and the like are prepared for each vehicle type. The vehicle information management apparatus appropriately selects image information corresponding to a vehicle type of the vehicle used by the user who has purchased the vehicle information from the plurality of pieces of image information to generate the image information.

The vehicle information management apparatus manages, for each user who has purchased the vehicle information, the vehicle information generated according to the vehicle used by the user in association with a user identification (ID). The association may be referred to as linkage.

<Viewing is Possible Before Delivery Date>

The vehicle information management apparatus permits viewing of the vehicle information including the generated image information from before the vehicle is delivered to the user (in other words, before the user starts using the vehicle).

Since the viewing of the vehicle information is permitted before the vehicle reaches (is delivered to) the user, the user can confirm a design of the vehicle, the setting states of the functions provided in the vehicle, and a maintenance state of the vehicle via the 3D image even without the actual vehicle.

<Vehicle Function Setting Is Possible>

In addition, in a case where a user who has connected a sensor that senses the user's action of bending, stretching, touching, holding, or turning an arm, and the above-described VR goggles to the communication terminal 2A performs a setting operation for the function provided in the vehicle while viewing the 3D image reflecting an operation member of the vehicle, the vehicle information management apparatus acquires operation information from the communication terminal 2A of the user. Then, data (setting information) indicating the setting state of the function provided in the vehicle is changed on the basis of the operation information acquired from the communication terminal 2A. The change of the setting information may be referred to as update of the setting information. Further, a corresponding function change instruction is transmitted to the vehicle used by the user (a dealership or the like in charge of the user in a case where the vehicle is before being delivered to the user) on the basis of the updated setting information.

In a case where the vehicle information management apparatus transmits the function change instruction to the dealership or the like, a mechanic or the like who inspects the vehicle before delivery at a service factory provided in the dealership or the like performs work of changing the function at the time of inspecting the vehicle before delivery.

With this configuration, the user can perform the function setting operation on the vehicle from the communication terminal 2A of the user before the vehicle is delivered. In addition, the user can experience operating the function of the vehicle through the 3D image even without the actual vehicle.

On the other hand, in a case where the vehicle information management apparatus transmits the change instruction to the vehicle (more precisely, an in-vehicle terminal mounted on the vehicle), the in-vehicle terminal of the vehicle performs a process of changing the function, for example, when a power switch of the vehicle is turned on.

With such a configuration, even when the user is away from the vehicle to be used, the user can perform the function setting operation on the vehicle from the communication terminal 2A of the user.

<Confirmation of Maintenance and Inspection Record is Possible>

In addition, in a case where inspection and maintenance is performed on the vehicle in a service factory or the like provided in a dealership after the user starts using the vehicle, the vehicle information management apparatus acquires such an inspection and maintenance record from a service terminal or the like of the service factory. Then, the latest inspection and maintenance record is included in the basic information.

With this configuration, the user can confirm the inspection and maintenance record from the communication terminal 2A of the user without looking up an inspection and maintenance record book of the vehicle.

<Status Information>

In the embodiment, the image information included in the vehicle information is treated as information indicating a status of the user who has purchased the vehicle information. The image information can include an image indicating the status of the user separately from the image of the vehicle used by the user.

The vehicle information management apparatus generates a character image having the vehicle as a motif, for example, as the image indicating the status of the user, and changes the character image as the status of the user is improved.

The vehicle information management apparatus prepares a plurality of pieces of image information in advance as image materials for generating a character image to be included in the vehicle information. For example, a plurality of images different in at least one of an appearance of a vehicle (a plurality of appearances depending on a difference in a vehicle type, a difference due to the presence or absence of an optional component, a difference due to an attitude of the vehicle, and the like) and a color difference of the vehicle or a component constituting the vehicle are prepared. The vehicle information management apparatus selects image information on the basis of an evaluation value to be described in detail later from among pieces of image information having the vehicle as the motif used by the user of the plurality of pieces of image information, and generates the character image corresponding to the status of the user.

Note that it is assumed that the character image in an initial mode included in the initial vehicle information purchased by the user represents, for example, the simple vehicle in a state where a color of the vehicle is uncolored and an optional component or the like that decorates the exterior of the vehicle is not mounted.

In a case where the vehicle used by the user satisfies a predetermined condition, the vehicle information management apparatus changes a mode of the character image included in the vehicle information owned by the user. For example, the vehicle included in the character image is decorated by changing the color of the vehicle or a component constituting the vehicle, mounting the optional component, or the like.

In the embodiment, as the status of the user becomes higher, more colors can be used for the character image, and more optional components can be mounted. In addition, a size of the vehicle included in the character image can be increased (zoomed up).

The predetermined condition is, for example, that the user goes to a facility or the like, provided at a place defined in advance, in the vehicle in use and uses the facility. The facility includes, for example, a plurality of charging stands (also referred to as charging spots or charging stations) provided at places defined in advance, respectively. Each of the charging stands is installed alone or is provided in a commercial facility, a parking lot of an office building, and the like. In addition, a characteristic information value unique to each of the charging stands used to calculate an evaluation value is defined for each of the charging stands.

When the user moves to a charging stand with the vehicle in use and performs charging, the vehicle information management apparatus calculates an evaluation value of the user based on a characteristic information value specific to the charging stand that has been used.

The vehicle information management apparatus generates a character image in which a mode of the vehicle included in the character image of the user is changed on the basis of a calculated value of the evaluation value.

The vehicle information management apparatus records the vehicle information including the character image in the distributed database network.

The change in the mode of the vehicle may be referred to as evolution of the vehicle. The character image is ranked in a plurality of stages according to the mode of the vehicle. By owning the character image, the user can receive at least one of a discount service such as a usage fee of a facility, a service that gives a point convertible to the usage fee, and a facility priority use service (which may be referred to as a benefit) according to a rank. The priority use service refers to a service that recognizes priority use of a user who owns a character image ranked higher, for example, in a case where a plurality of users waits for an order of using a facility. In addition, the number of items that can be used in a VR space may be increased according to a rank of the character image.

The ownership of the character image can be transferred or leased.

Such a vehicle information management apparatus will be described in more detail.

<Outline of Vehicle Information Management System>

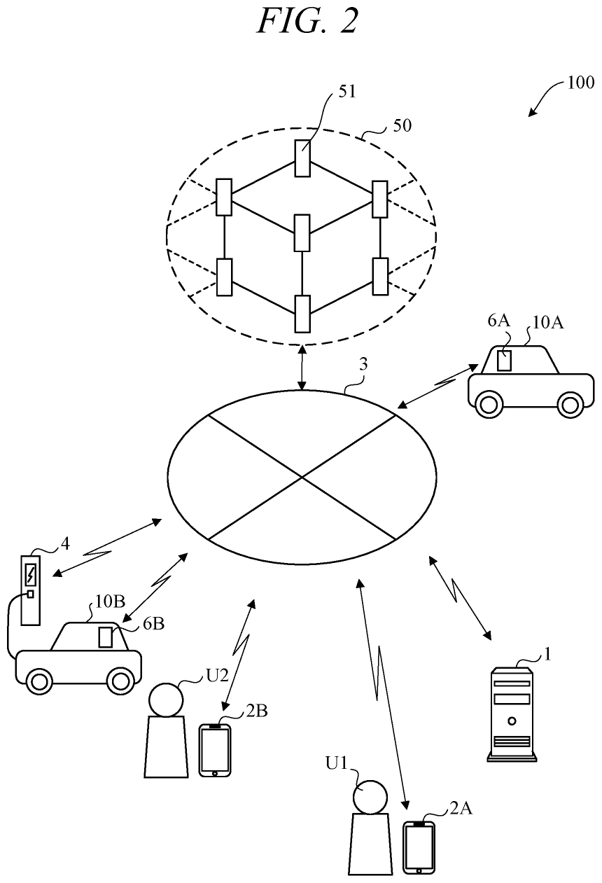

FIG. 2 is a schematic configuration diagram of a vehicle information management system 100 according to the embodiment. Examples of the vehicle information management system 100 include a vehicle 10A used by a user U1, the communication terminal 2A used by the user U1, a vehicle 10B used by a user U2, a communication terminal 2B used by the user U2, a charging stand 4 as a predetermined facility, a server device 1 as the vehicle information management apparatus, and a distributed database network 50.

In-vehicle terminals 6A and 6B, the communication terminals 2A and 2B, the charging stand 4, the server device 1, and the distributed database network 50 mounted on the vehicles 10A and 10B, respectively, are configured to be able to communicate with each other via a communication network 3. The communication network 3 includes not only public wireless communication networks represented by Internet networks and cell phone networks, but also closed communication networks established for each predetermined administrative region, such as wireless local area network (LAN), Wi-Fi (registered trademark), and the like.

Although the vehicles 10A and 10B, the communication terminals 2A and 2B, and the charging stand 4 are indicated in FIG. 2, there may be more vehicles used by other users other than the users U1 and U2, more communication terminals used by other users other than the users U1 and U2, and more facilities including other charging stands and the like other than the charging stand 4 without being limited to the illustrated number.

The server device 1 is managed and operated by a business entity P that runs a vehicle information management business or a business operator Q entrusted with the vehicle information management business. Details of the server device 1 will be described later.

The charging stand 4 or the like is managed and operated by a business entity R or the like that runs a charging business for vehicles equipped with a battery. The charging stand 4 or the like includes a control unit, a communication unit, and an authentication unit (not illustrated), and confirms the user U2 who has registered credit card information or the like in advance, for example, when the user U2 holds the communication terminal 2B over the authentication unit. In addition, the charging stand 4 or the like performs a process of charging a usage fee or the like of the facility for the registered credit card.

Furthermore, the charging stand 4 or the like transmits identification information unique to the charging stand, information on an authenticated user, information indicating a charging amount or the like used by the user, and information indicating a time zone used by the user from the communication unit of the charging stand 4 or the like to the server device 1 or the like via the communication network 3.

The communication terminals 2A and 2B are configured using smartphones or the like used by the users U1 and U2, respectively. Instead of the smartphones or the like, functions of the communication terminals 2A and 2B may be substituted by the in-vehicle terminals 6A and 6B mounted on the vehicles 10A and 10B used by the users U1 and U2, respectively, or the communication terminals 2A and 2B used by the users U1 and U2 and the in-vehicle terminals 6A and 6B of the respective vehicles may be used in cooperation by short-range wireless communication or the like.

The distributed database network 50 includes a network in which processing devices of an unspecified number of participants exist. The distributed database network 50 connects a plurality of processing devices 51 each including a storage unit and a processor (not illustrated) to one another. Each node is configured using one or a plurality of the processing devices 51, and information stored in each of the storage units is verified between the nodes.

The distributed database network 50 is robust to tampering of information, and thus, is used for authenticity proof of information. In the embodiment, vehicle information generated by the server device 1 is also recorded in the distributed database network 50, thereby enabling an authenticity determination of the vehicle information.

Since such a distributed database network 50 is known, a detailed description thereof will be omitted.

The server device 1 supplies application software (hereinafter referred to as a service-use application) for use of the vehicle information management service to the communication terminals 2A and 2B via the communication network 3 in response to requests from the communication terminals 2A and 2B, respectively. The communication terminals 2A and 2B that have received the supply of the service-use application from the server device 1, in other words, have downloaded the service-use application can execute the service-use application for using the vehicle information management service.

<Server Device>

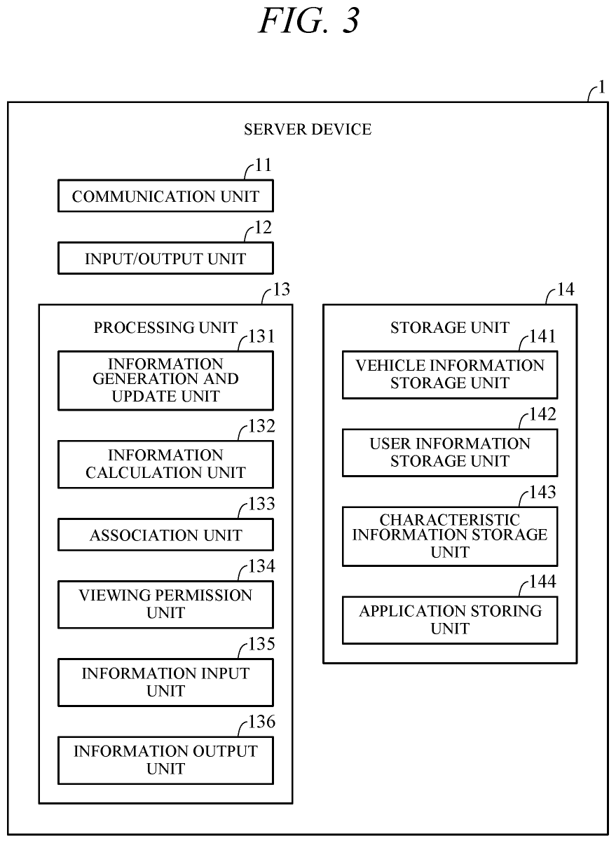

FIG. 3 is a block diagram illustrating a configuration of a main part of the server device 1 of FIG. 2. As described above, the server device 1 is managed by the business entity P that provides the service or the like. The server device 1 may be configured using a virtual server function on a cloud, or may be configured to be distributed to a plurality of terminals.

The server device 1 includes a communication unit 11, an input/output unit 12, a processing unit 13, and a storage unit 14. The communication unit 11 is configured to be able to communicate with external devices such as the distributed database network 50, the communication terminals 2A and 2B, the in-vehicle terminals 6A and 6B mounted on the vehicles 10A and 10B, and the charging stand 4 via the communication network 3. With such a configuration, the server device 1 can transmit and receive necessary information to and from the distributed database network 50, the communication terminals 2A and 2B of the users U1 and U2 of the service-use application, the charging stand 4, and the like.

It is assumed that the users U1 and U2 who wish to use the service-use application register user information with the business entity P who provides the service or the like, and then receive the supply of the service-use application stored in an application storing unit 144 of the storage unit 14. It is assumed that pieces of the registered user information of the plurality of users U1 and U2 are stored in a user information storage unit 142 of the storage unit 14.

The user information is registered using the communication terminals 2A and 2B or the like that can communicate with the server device 1. The user information can include, for example, a user ID, an address, a name, a date of birth, a telephone number, credit card information, a contact address, and the like.

Along with the registration of the user information, information such as vehicle IDs of the vehicles 10A and 10B and models of the vehicles 10A and 10B used by the users U1 and U2 may be registered.

It is assumed that vehicle information purchased by the users U1 and U2 is stored in a vehicle information storage unit 141 of the storage unit 14.

The input/output unit 12 includes, for example, a keyboard, a pointing device, a display, a touch panel, and the like. The input/output unit 12 transmits a signal, input on the basis of operations of the keyboard, the pointing device, the touch panel, and the like, to the processing unit 13, and displays information based on the signal output from the processing unit 13 on the display or the like.

The processing unit 13 includes a computer including a CPU (microprocessor) and its peripheral circuits. The processing unit 13 executes predetermined processing on the basis of a signal input via the input/output unit 12, a signal received from the outside of the server device 1 via the communication unit 11, data stored in the storage unit 14, and the like, and outputs a control signal to the communication unit 11, the input/output unit 12, and the storage unit 14.

The processing unit 13 functions as an information generation and update unit 131, an information calculation unit 132, an association unit 133, a viewing permission unit 134, an information input unit 135, and an information output unit 136 by executing a program stored in advance in the storage unit 14.

The information generation and update unit 131 generates vehicle information including image information, basic information, and setting information as a non-fungible token (NFT) recorded in a blockchain. In addition, the information generation and update unit 131 generates the image information to be included in the vehicle information, generates a character image including a vehicle in the initial mode, and updates the character image to a character image including the vehicle that has been decorated.

The information calculation unit 132 calculates an evaluation value for each user.

Prior to the evaluation value calculation, the processing unit 13 reads, from a characteristic information storage unit 143, characteristic information corresponding to identification information of the charging stand 4 or the like transmitted from the charging stand 4 or the like. For example, a value different for each charging stand can be set as the characteristic information.

The characteristic information is determined in advance by the processing unit 13, and is stored in the characteristic information storage unit 143 in association with the identification information of the charging stand 4 or the like. As described above, a change in a mode of a vehicle is one of decorations, and the mode of the vehicle of a character image is changed greatly as characteristic information with a larger value is set for the charging stand 4 or the like used by the users U1 and U2.

For example, in order to level utilization rates of the charging stand 4 and other charging stands, the processing unit 13 may set characteristic information with a larger value for a charging stand where many customers are less likely to gather as compared with characteristic information of a charging stand where many customers gather.

In addition, for example, in order to level utilization rates in daytime and nighttime at the same charging stand, the processing unit 13 may set characteristic information with a larger value in a time zone in which the number of customers decreases as compared with characteristic information set in a time zone in which the number of customers increases.

Note that, as travel distances of the vehicles 10A and 10B from a charging stand used last time to a charging stand used currently are longer, the processing unit 13 may set a larger value of characteristic information in the current use. As travel distance information, for example, values acquired from the in-vehicle terminals 6A and 6B of the vehicles 10A and 10B used by the users U1 and U2 may be used.

The information calculation unit 132 calculates an evaluation value for each user using the above-described characteristic information. For example, an evaluation value is calculated by putting the characteristic information into a predetermined calculation formula. The calculation formula of an evaluation value is defined by the processing unit 13 such that a calculated value of an evaluation value of a user becomes larger and a change in a mode of a vehicle of a character image further progresses when a use situation of the vehicle 10A or 10B by the user U1 or U2 is good (for example, a facility (a charging stand, a dealership, or the like) at a place defined in advance is being used and a traveling speed of the vehicle 10A or 10B is within a limit speed defined for a traveling road).

The association unit 133 associates vehicle information, a user ID of a user who has purchased the vehicle information, and a vehicle ID of a vehicle used by the user.

As described above, the viewing permission unit 134 permits the user U1 or the like to view the vehicle information regarding the vehicle 10A or the like used by the user U1 or the like via the communication terminal 2A or the like used by the user U1 or the like.

The information input unit 135 inputs information received from the outside of the server device 1 via the communication unit 11, data stored in the storage unit 14, and the like to the processing unit 13. The information from the outside of the server device 1 includes the user ID and the other information received from the communication terminal 2A or the like of the user U1 or the like, the identification information of the charging stand 4 or the like and information regarding the user received from the charging stand 4 or the like, the information regarding the character image received from the distributed database network 50, and the like.

The information output unit 136 outputs information to the outside of the server device 1 via the communication unit 11. The information to be output to the outside of the server device 1 includes the service-use application and the other information to be transmitted to the communication terminals 2A and 2B of the users U1 and U2, the information to be transmitted to the charging stand 4 or the like, the vehicle information to be transmitted to the distributed database network 50, and the like.

In the embodiment, every time the information generation and update unit 131 generates or updates the vehicle information, generation history information is recorded in both the server device 1 (the vehicle information storage unit 141) and the distributed database network 50. Therefore, even if the record is tampered on the server device 1 side, for example, the tampering can be easily detected by collating a hash value of tampered information with a hash value on the distributed database network 50.

In addition, the generation history information can be always confirmed by a third party on the distributed database network 50, and thus, it is possible to verify whether or not a transaction partner is a true owner in a transaction using the vehicle information. For example, when a user who owns vehicle information receives a benefit from the server device 1 (for example, a usage fee discount service, a facility priority use service, or the like), it is possible to verify the authenticity of the vehicle information (particularly, a character image) owned by the user.

The storage unit 14 includes a volatile or nonvolatile memory (not illustrated). The storage unit 14 stores various programs, various data, and the like to be executed by the processing unit 13. In addition, the storage unit 14 functions as the vehicle information storage unit 141, the user information storage unit 142, the characteristic information storage unit 143, and the application storing unit 144.

The vehicle information storage unit 141 stores pieces of the vehicle information regarding the vehicles 10A and 10B used by the registered users U1 and U2 of the service-use application and generated by the information generation and update unit 131 in association with the user IDs.

The user information storage unit 142 stores pieces of the user information of the users in association with the user IDs.

The characteristic information storage unit 143 stores the characteristic information determined by the processing unit 13 in association with the identification information of the charging stand 4 or the like.

The application storing unit 144 stores the service-use application to be provided to the user U1 and the like.

<Communication Terminal>

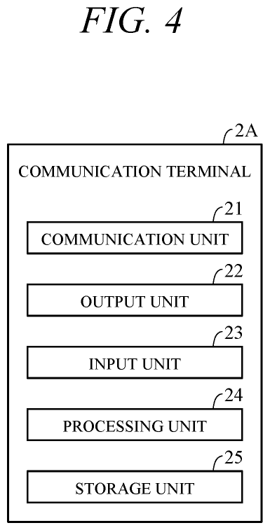

FIG. 4 is a block diagram illustrating a configuration of a main part of the communication terminal 2A. A configuration of the communication terminal 2B is similar to that of the communication terminal 2A. As illustrated in FIG. 4, the communication terminal 2A includes a communication unit 21, an output unit 22, an input unit 23, a processing unit 24, and a storage unit 25. The communication terminal 2A is configured using a device connectable to the communication network 3, such as a smartphone operated by the user U1.

The communication unit 21 is configured to be able to communicate with the server device 1 and the like via the communication network 3.

The output unit 22 includes, for example, a display unit that displays text information, images, and others, and a speaker unit that plays back sound and the like.

The input unit 23 includes various switch units operated by the user U1 such as a touch operation member and a keyboard, a microphone unit that inputs a voice uttered by the user U1, and the like. The user U1 inputs various types of information via the input unit 23.

The processing unit 24 includes a microcomputer and its peripheral circuits. The processing unit 24 executes predetermined processing on the basis of a signal input via the input unit 23, a signal received from an external device via the communication unit 21, data stored in the storage unit 25, and the like, and outputs a control signal to each unit of the communication terminal 2A such as the communication unit 21, the output unit 22, and the storage unit 25.

The processing unit 24 further outputs a control signal to the communication unit 21 to control transmission and reception of a signal between the communication terminal 2A and the server device 1 and transmission and reception of a signal between the communication terminal 2A and the in-vehicle terminal 6A. The processing performed by the processing unit 24 enables the user U1 to confirm the vehicle information regarding the vehicle 10A, change the registered user information, and the like while viewing information displayed on the output unit 22.

The storage unit 25 includes a volatile or nonvolatile memory (not illustrated). The storage unit 25 stores various programs and various data to be executed by the processing unit 24. The storage unit 25 further stores user information and the like.

<In-Vehicle Terminal>

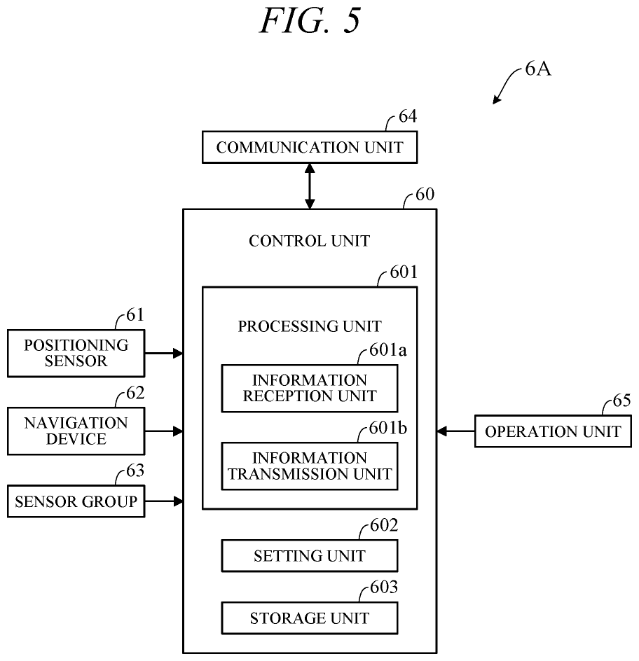

FIG. 5 is a block diagram illustrating a configuration of a main part of the in-vehicle terminal 6A. A configuration of the in-vehicle terminal 6B is similar to that of the in-vehicle terminal 6A. As illustrated in FIG. 5, the in-vehicle terminal 6A includes a control unit 60, a positioning sensor 61, a navigation device 62, a sensor group 63, a communication unit 64, and an operation unit 65.

The positioning sensor 61 receives a positioning signal transmitted from a GPS satellite or the like. The positioning sensor 61 measures a current position of the vehicle 10A based on the received positioning signal. The navigation device 62 is a device that searches for a target route on roads to a destination that has been input by the user U1 and that also gives guidance along the target route. The destination is input via the operation unit 65.

The sensor group 63 is a general term for a plurality of sensors that detect a state and the like of the vehicle 10A. As an example, the sensor group 63 includes a vehicle speed sensor that detects a traveling speed (vehicle speed) of the vehicle 10A, a gyro sensor that detects an angular velocity of the vehicle 10A, and the like.

The processing unit 601 calculates the current position of the vehicle 10A by autonomous navigation calculation processing based on the positioning signal received by the positioning sensor 61 or a detection signal such as a yaw rate detected by the gyro sensor or the vehicle speed detected by the vehicle speed sensor.

The communication unit 64 is configured to be able to wirelessly communicate with an external device such as the server device 1 via the communication network 3. Note that the communication unit 64 is also configured to be able to transmit and receive information to and from the communication terminal 2A by short-range wireless communication such as Bluetooth (registered trademark) without the communication network 3, for example, in a case where the user U1 using the communication terminal 2A is riding the vehicle 10A.

The control unit 60 includes a computer including a processing unit 601 such as a microcomputer, a setting unit 602 that sets a function provided in the vehicle 10A, a storage unit 603 such as a ROM, a RAM, and a hard disk, and other peripheral circuits (not illustrated). The processing unit 601 functions as an information reception unit 601a and an information transmission unit 601b by executing a program stored in advance in the storage unit 603.

The information reception unit 601a receives various types of information and various signals detected by each unit of the in-vehicle terminal 6A. For example, the information reception unit 601a receives position information of the vehicle 10A measured by the positioning sensor 61, the detection signal by the sensor group 63, and the like.

The information transmission unit 601b is configured to be able to transmit various types of information and various signals received by the information reception unit 601a to the communication terminal 2A or the like or an external device such as the server device 1 via the communication unit 64 as necessary. For example, the position information of the vehicle 10A calculated by the processing unit 601 is transmitted to the server device 1.

<Description of Flowchart>

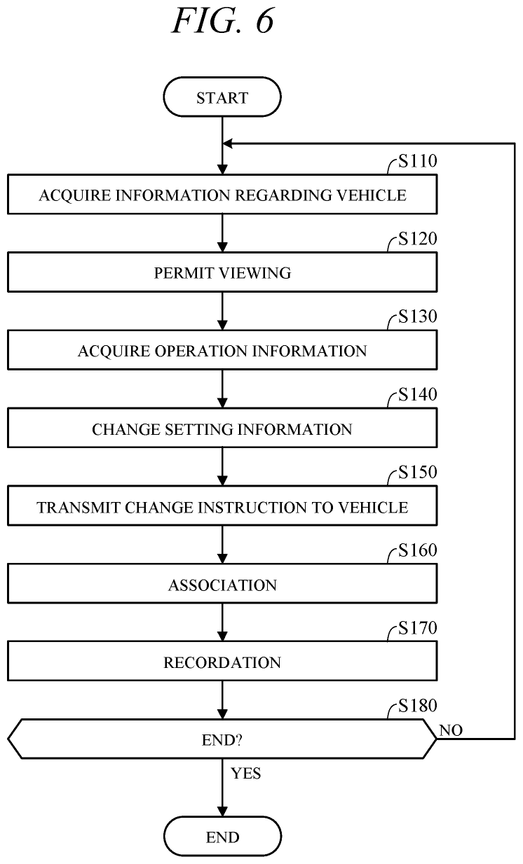

FIG. 6 is a flowchart illustrating a flow of vehicle information management processing performed by the server device 1. For example, when a predetermined login operation is performed through the communication terminal 2A or the like used by the user U1 or the like, the processing unit 13 of the server device 1 performs login processing and starts the processing along steps illustrated in FIG. 6. A user ID or the like is input by the login operation.

In S110 (S represents a processing step), the processing unit 13 acquires information regarding the vehicle 10A or the like used by the user U1 or the like. After reading vehicle information associated with the user ID from the vehicle information storage unit 141, the processing unit 13 proceeds to S120. The vehicle information includes image information illustrating at least one of the whole and a part of the vehicle 10A or the like and setting information indicating a setting state of a function provided in the vehicle 10A or the like included by the information generation and update unit 131.

In S120, the processing unit 13 functions as the viewing permission unit 134 to permit viewing of the vehicle information regarding the vehicle 10A or the like used by the user U1 or the like, and proceeds to S130. As described above, even before the user U1 or the like starts using the vehicle 10A or the like, the processing unit 13 permits the viewing of the vehicle information.

In S130, the processing unit 13 acquires operation information from the communication terminal 2A or the like used by the user U1 or the like, and proceeds to S140. The operation information is, for example, information obtained by sensing, by the above-described sensor that senses an action, a function setting operation performed by the user U1 or the like while viewing a 3D image reflecting an operation member of the vehicle 10A or the like displayed on the communication terminal 2A or the like.

In S140, the processing unit 13 functions as the information generation and update unit 131 to change (also referred to as update) the setting information indicating the setting state of the function provided in the vehicle 10A or the like on the basis of the operation information, and proceeds to S150.

In S150, the processing unit 13 transmits a corresponding function change instruction to the vehicle 10A or the like on the basis of the updated setting information, and proceeds to S160. Note that, as described above, the change instruction is transmitted to a dealership or the like instead of the vehicle 10A or the like in a case where the vehicle 10A or the like is before being delivered to the user U1 or the like.

In S160, the processing unit 13 functions as the association unit 133 to associate the vehicle information (including the changed setting information) for each of the user U1 and the like with the user ID. After the association unit 133 performs the association, the processing unit 13 proceeds to S170.

In S170, the processing unit 13 performs recording processing. The processing unit 13 records the vehicle information in not only the vehicle information storage unit 141 but also the distributed database network 50, and proceeds to S180.

In S180, the processing unit 13 determines whether or not to end the processing. When a predetermined logoff operation is performed through the communication terminal 2A or the like used by the user U1 or the like, the processing unit 13 makes an affirmative determination in S180 and ends the processing in FIG. 6. When the logoff operation is not performed, the processing unit 13 makes a negative determination in S180 and repeats the processing in FIG. 6.

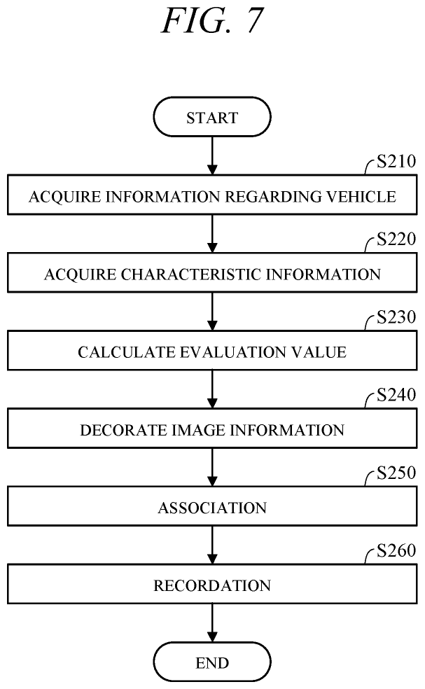

FIG. 7 is a flowchart illustrating a flow of another vehicle information management processing performed by the server device 1. For example, when information indicating that the vehicle 10A or the like used by the user U1 or the like satisfies a predetermined condition is input from the charging stand 4 or the like to the information input unit 135, the processing unit 13 of the server device 1 starts the processing along steps illustrated in FIG. 7. The information input from the charging stand 4 or the like includes identification information of the charging stand 4 or the like and information regarding the user U1 or the like including a user ID of the user U1 or the like who has used the charging stand 4 or the like.

In S210, the processing unit 13 acquires information regarding the vehicle 10A or the like used by the user U1 or the like. After reading vehicle information associated with the user ID from the vehicle information storage unit 141, the processing unit 13 proceeds to S220.

Note that a character image in image information included in the vehicle information associated with a user ID of a user who has not yet used the charging stand 4 or the like (in the case of having been just registered) is a character image in an initial mode.

In S220, the processing unit 13 acquires characteristic information. More specifically, after reading the characteristic information corresponding to the identification information of the charging stand 4 or the like from the characteristic information storage unit 143, the processing unit 13 proceeds to S230.

In S230, the processing unit 13 functions as the information calculation unit 132 to calculate an evaluation value for each user. When the information calculation unit 132 puts the characteristic information into a predetermined calculation formula to calculate the evaluation value, the processing unit 13 proceeds to S240.

In S240, the processing unit 13 functions as the information generation and update unit 131 to decorate the character image for each user. When the information generation and update unit 131 generates a character image in which a mode of a vehicle included in the character image for each user has been changed on the basis of the calculated evaluation value, the processing proceeds to S250. The information generation and update unit 131 may use a table indicating a relationship between a calculated value of the evaluation value and a mode of a vehicle in a character image when generating the character image. For example, when the calculated value is input to the table, data of the corresponding character image is output from the table.

In S250, the processing unit 13 functions as the association unit 133 to associate the vehicle information (including the character image) of each user with the user ID. After the association unit 133 performs the association, the processing unit 13 proceeds to S260.

In S260, the processing unit 13 performs recording processing. The processing unit 13 records the vehicle information including the character image in not only the vehicle information storage unit 141 but also the distributed database network 50.

The processing unit 13 further records use history information on the charging stand 4 or the like in the user information storage unit 142, and ends the processing in FIG. 7.

In the embodiment described above, the user U1 and the like may teach each other a method for evolving a vehicle of a character image as status information between users. For example, information such as the order of use of the charging stand 4 or the like, a use time (charging time) of the charging stand 4 or the like per use, and a use time zone of the charging stand 4 or the like may be exchanged using a social networking service (SNS) or the like as a method of mounting an optional component faster and a method of coloring a vehicle having a character image with a rare color faster.

In addition, the user U1 or the like may post the character image owned by the user on the SNS or the like to introduce the character image to other users. The other users can know an evolved figure of the vehicle in the character image.

Furthermore, the user U1 and the like may trade pieces of image information (as well as vehicle information) including the character image owned by the respective users. Since the vehicle information is recorded in the distributed database network 50, it is possible to verify the ownership with reference to data on the blockchain, and thus, it is possible to perform a continuous transaction. Note that information indicating a change history of the vehicle of the character image may be added to the data on the blockchain.

According to the above-described embodiment, the following effects can be achieved.

(1) A vehicle information management method for managing vehicle information linked with the vehicle 10A or the like used by the user U1 or the like includes: as a first step, including a character image as status information indicating a status of the vehicle information into the vehicle information by the information generation and update unit 131; as a second step, decorating the character image according to travel information of the vehicle 10A or the like by the information generation and update unit 131; as a third step, permitting the user U1 or the like of the vehicle 10A or the like to view the vehicle information via the communication terminal 2A or the like, which is an information terminal, by the viewing permission unit 134; and as a fourth step, generating the vehicle information as a non-fungible token to be recorded in a blockchain by the information generation and update unit 131.

With this configuration, it is possible to encourage the user U1 or the like who is interested in decorating the character image to travel in the vehicle 10A or the like.

For example, evolution of the vehicle caused by the decoration is apparent at a glance in the character image, and thus, the user U1 or the like can travel while enjoying the evolution of the vehicle of the character image. As a result, the convenience of the user U1 or the like who uses the vehicle information is enhanced.

In addition, the inclusion of the fourth step enables an authenticity determination of the vehicle information, and enables the vehicle information to be treated as a one-of-a-kind existence.

(2) The travel information in the above-described (1) is information indicating a travel distance or a travel time of the vehicle 10A or the like or arrival at a plurality of predetermined places.

With this configuration, it is possible to cause the user U1 or the like to travel for the travel distance or travel time defined in advance in the vehicle 10A or the like, or to move to the places defined in advance in the vehicle 10A or the like.

(3) Each of the plurality of predetermined places in the above-described (2) has pieces of characteristic information different from each other, and the information generation and update unit 131 decorates the character image on the basis of the characteristic information when arriving at the predetermined places in the second step.

With this configuration, for example, the user U1 or the like can be attracted to a place having the characteristic information that greatly contributes to the decoration of the vehicle with the character image, and the user U1 or the like can move to the place in the vehicle 10A or the like.

(4) The plurality of predetermined places are charging facilities for the vehicle 10A or the like.

With this configuration, it is possible to cause the user U1 or the like to be attracted to the charging stand 4 or the like to encourage the user U1 or the like to use the charging stand 4 or the like.

(5) The charging stand 4 or the like as the charging facility in the above-described (4) has different characteristic information depending on the origin of power to be supplied.

With such a configuration, it is possible to increase the contribution to the evolution of the vehicle of the character image when the charging stand 4 or the like is used, for example, by setting a value of the characteristic information of the charging stand 4 or the like covered by power obtained by power generation using renewable energy such as sunlight, wind power, and geothermal heat to be larger than those of characteristic information of other charging stands that do not use the renewable energy. As a result, the user U1 or the like can be encouraged to use the renewable energy.

(6) The vehicle information management method in the above-described (1) further includes, as a fifth step, including image information in which a stereoscopic view or a planar view of data of an image indicating the vehicle 10A or the like is possible into the vehicle information by the information generation and update unit 131.

With this configuration, the user U1 or the like can confirm a design of the vehicle 10A or the like through the communication terminal 2A or the like from a 3D image or a 2D image based on the vehicle information.

(7) The vehicle information management method in the above-described (1) further includes: as a sixth step, including setting information indicating a setting state of a function provided in the vehicle 10A or the like into the vehicle information by the information generation and update unit 131; as a seventh step, updating the setting information on the basis of operation information from the communication terminal 2A or the like by the information generation and update unit 131; and as an eighth step, issuing a function change instruction corresponding to the updated setting information to the vehicle 10A or the like by the processing unit 13.

With such a configuration, even when the user U1 or the like stays in a site away from the vehicle 10A or the like, it is possible to confirm the setting state of the function provided in the vehicle 10A or the like and update the setting state of the function. In addition, even when the user U1 or the like stays in a site away from the vehicle 10A or the like, it is possible to change the function of the vehicle 10A or the like.

The above embodiment may be modified into various forms. Hereinafter, modifications will be described.

### FIRST MODIFICATION

Although the charging stand 4 or the like has been exemplified as the facility used by the user U1 and the like, a refueling stand may be used as a facility as long as the user U1 and the like move in the vehicle 10A or the like and use the facility. In addition, commercial facilities that provide other products or services may be used without being limited to charging and refueling.

### SECOND MODIFICATION

The processing unit 13 may set a larger value of characteristic information in the current use as a charging amount or an oil supply amount is larger. According to a second modification, a calculated value of an evaluation value is larger when the charging amount or the oil supply amount is larger, and the evolution of the vehicle of the character image progresses.

### THIRD MODIFICATION

Although the example in which the data of the image related to the vehicle of the same vehicle type as the vehicle used by the user is used as the image information has been described in the embodiment, data of an image related to an unsold vehicle such as a vehicle sold in the past, a prototype vehicle, or a concept model may be used as the image information. Note that, in a third modification, basic information may be omitted from vehicle information because the information is not related to the vehicle used by the user.

The above embodiment can be combined as desired with one or more of the aforesaid modifications. The modifications can also be combined with one another.

According to the present invention, it becomes possible to enhance convenience of a user who uses a vehicle (moving body).

Above, while the present invention has been described with reference to the preferred embodiments thereof, it will be understood, by those skilled in the art, that various changes and modifications may be made thereto without departing from the scope of the appended claims.

1. A vehicle information management method for managing vehicle information linked with a vehicle, comprising the steps of:
including status information indicating a status of the vehicle information into the vehicle information;
decorating the status information based on travel information of the vehicle;
permitting a user of the vehicle to view the vehicle information through an information terminal; and
generating the vehicle information as a non-fungible token to be recorded in a blockchain.

2. The vehicle information management method according to claim 1, wherein
the travel information is information indicating at least one of: a travel distance;
a travel time; and an arrival at a plurality of predetermined places of the vehicle.

3. The vehicle information management method according to claim 2, wherein
each of the plurality of predetermined places includes characteristic information different from each other, wherein
the decorating includes decorating the status information based on the characteristic information when the vehicle arrives at any one of the plurality of predetermined places.

4. The vehicle information management method according to claim 3, wherein
the plurality of predetermined places are charging facilities or refueling facilities for the vehicle.

5. The vehicle information management method according to claim 4, wherein
the characteristic information of the charging facilities or the refueling facilities are different from each other in accordance with origins of power to be charged of fuel to be refueled.

6. The vehicle information management method according to claim 1, further comprising the steps of:
including image information, in which a stereoscopic view or a planar view of data of an image indicating the vehicle is possible, into the vehicle information.

7. The vehicle information management method according to claim 1, further comprising the steps of:
including setting information indicating a setting state of a function provided in the vehicle, into the vehicle information;
updating the setting information based on operation information from the information terminal; and
issuing an instruction to change a function corresponding to the setting information after the updating to the vehicle.

8. A vehicle information management apparatus configured to manage vehicle information linked with a vehicle, comprising:
a processor and a memory coupled to the processor, wherein
the processor is configured to perform:
including status information indicating a status of the vehicle information into the vehicle information;
decorating the status information based on travel information of the vehicle;
permitting a user of the vehicle to view the vehicle information through an information terminal; and
generating the vehicle information as a non-fungible token to be recorded in a blockchain.
